(19) United States
(12) Patent Application Publication
(10) Pub. No.: US 2012/0227562 A1
(43) Pub. Date: Sep. 13, 2012

(54) VERSATILE SAW

(76) Inventor: CLAUDE A. GINGRAS, Dosquet (CA)

(21) Appl. No.: 13/480,086

(22) Filed: May 24, 2012

Related U.S. Application Data
(63) Continuation-in-part of application No. 12/387,689, filed on May 4, 2009.

(51) Int. Cl. B23D 47/02

(52) U.S. Cl. 83/471.3

(57) ABSTRACT

A circular saw with a 10 foot-diameter or greater attached to a mast of a hydraulic shovel is mounted on a support device 23 attached to a rotation base 38 with a rotation screw 30 fixed peripherally to the rotation base. This rotation base 38 acts as a turret driven by a ring gear 40 commanded by a pinion gear 41 driven by a hydraulic motor 72, thereby providing a 360 degrees horizontal rotation of the saw around the rotation base. Furthermore, the rotation screw 30 allows the support device 23 to move the saw from an initial position face to the ground to a vertical position and even to 135 degrees, thereby providing a sawing action in space while rotating around the rotation base and being raised. Cutting and polishing teeth are respectively located in a peripheral circumference and on an external side of the saw.

The present invention is a Continuation in part of a prior application U.S. Ser. No. 12/387,689 filed on May 4, 2009 for a circular saw mounted on a swing base which provides a 360 degree horizontal rotation of the saw around the base. The saw could also be elevated from its initial position face to the ground to a raised position.

### BACKGROUND OF THE INVENTION

### Description of the Prior Art

The present invention refers to a preceding invention of the same author U.S. Ser. No. 12/387,689.

A search in the prior art revealed some systems that caught our attention:

KELLY U.S. Pat. No. 5,676,125 <<EXCAVATOR MOUNTED SAW>> discloses a rotary disk saw adapted to be mounted on an earth excavator or the like, having an articulating and rotatable member for a boom 30. There is a hydraulic cylinder 50 attached to an upstanding bracket 52 mounted on the saw carrying boom 30. By extending the piston cylinder 50, or contracting the same, the boom 30 rotates longitudinally about the pivot pin 36, thereby providing an orthogonal and longitudinally angular positioning of the saw (S).

KIMURA (U.S. Pat. No. 6,286,905) shows a cutting device 10 comprising a guide rail 12 horizontally fixed to a guide supporting member 11, a rack 30 placed on the upper surface of the guide rail 12, a cutter 60 moving on the rack 30 parallel to the longitudinal direction of the guide rail 12.

### OBJECTIVES OF THE INVENTION

There is a great need in the construction and demolition market for a saw used to cut stone, rock, concrete, asphalt, steel, wood or other materials, and designed in a way to be used in all angular positions. Our saw is mounted on support device mounted on a lower rotation base by means of a rotation screw. This rotation base acts as a turret system having a rack rail commanded by a pinion gear driven by a hydraulic motor, thereby allowing the rotation of the saw along the rotation base.

Furthermore, the rotation screw allows the saw to move from an initial position face to the ground to a vertical position and even to 135 degrees by the use of a hydraulic cylinder fixed to the rotation base by a dowel and causing an angular displacement of the support. Thereby providing a sawing action in space while rotating around the rotation base and being raised.

### BRIEF DESCRIPTION OF THE DRAWINGS

FIG. 1 is a view of the device as seen by an operator.

FIG. 2A is a front view of the saw in vertical position.

FIG. 2B is a rear view of the saw in vertical position.

FIG. 3 is a side view of the saw in 90 degree position.

FIG. 4 is a top view of rack and pinion, the saw in vertical position.

FIG. 5A is a front view of the saw with polishing teeth.

FIG. 5B is a face view of a tooth mounted on a shank.

FIG. 5C is a face view of a tooth mounted on an angled shank.

FIG. 6 is an end view of a segment of a cut saw.

### DETAILED DESCRIPTION OF THE PREFERRED EMBODIMENTS

The following description and the related drawings contain same numbers that is related to same parts of different drawings.

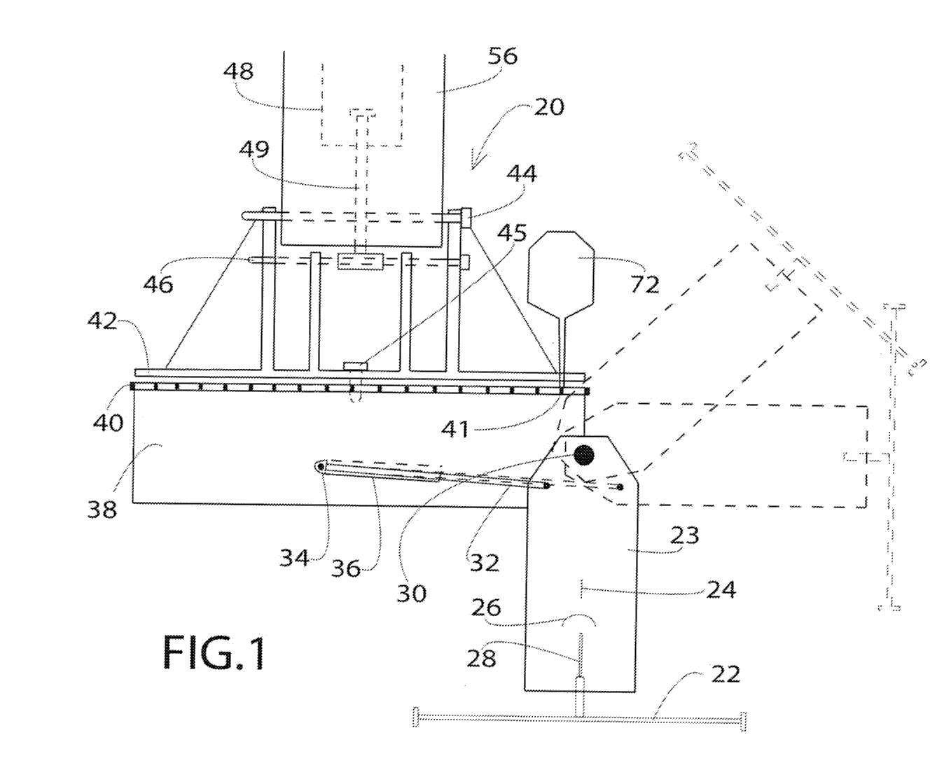

FIG. 1 shows a swing base 20 at the end of which a circular saw 22 is mounted perpendicularly to one end of a support device 23 with a stand 26 circling a rotation shaft 28 of the circular saw 22. An inner motor 24 is installed inside the circular saw 22. The support device 23 moves around a rotation screw 30 with a hydraulic cylinder of angular displacement 32 allowing the saw to move itself angularly along a plane from 0 to a vertical position and even to more than 180 degrees, the rotation screw 30 is peripheral to a lower rotative base 38 that turns around a central axis 45 and is driven by a turret 40 moved by a pinion gear 41, that provides a 360 degree rotation. The rack rail is commanded by a hydraulic motor 72 driving the pinion gear 41. An upper fixed plate 42 is linked to an arm 56 of a hydraulic shovel by two dowels 44 et 46. The circular saw 22 can be seen in three angular positions 0, 90 and 135 degrees. One can see the hydraulic cylinder of angular displacement support 36 of the circular saw 22. The hydraulic cylinder of angular displacement support 36 is set to the lower rotative base 38 by a dowel 34. One sees the hydraulic cylinder of the shovel 49 and the box of the hydraulic cylinder of the shovel 48.

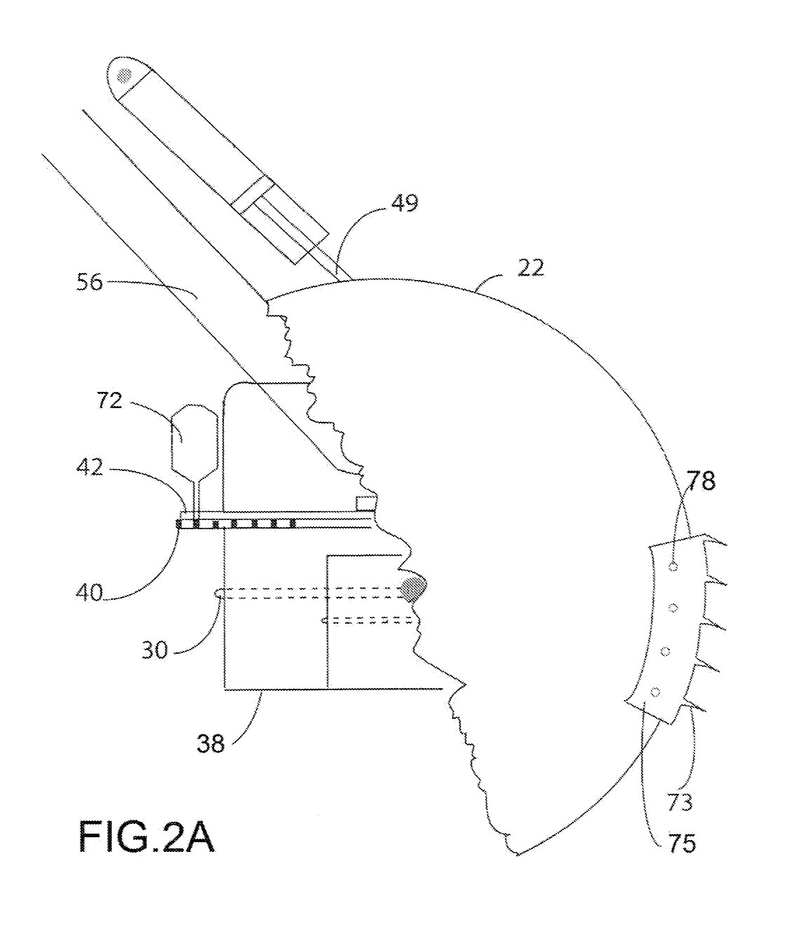

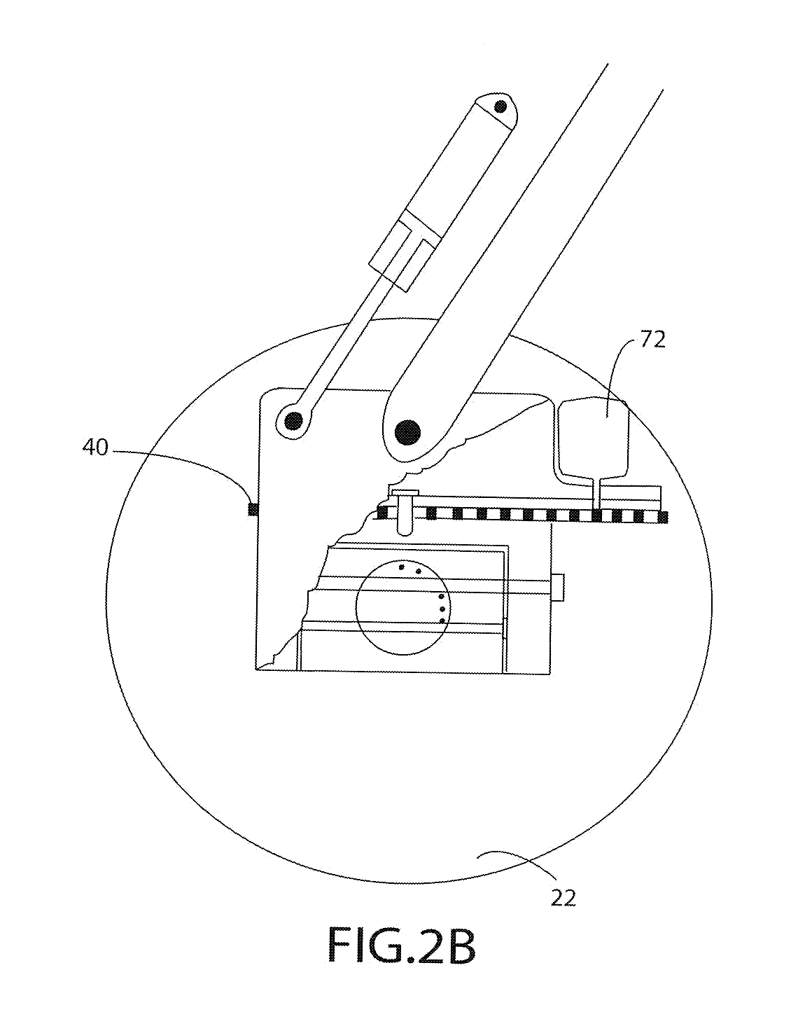

FIG. 2A shows the front view of the circular saw 22. One sees the arm 56 and the hydraulic cylinder of the shovel 49. The inside view shows the lower rotative base 38 turning from the turret 40 and the upper fix plate 42. The hydraulic motor 72 is fixed on the turret 40 at an outside end. The saw is shown with a segment 76 with its cutting teeth 73 and its clipping bolts 78.

FIG. 2B shows a rear view of the circular saw 22, with the hydraulic motor 72 fixed on the turret 40 to one outside end.

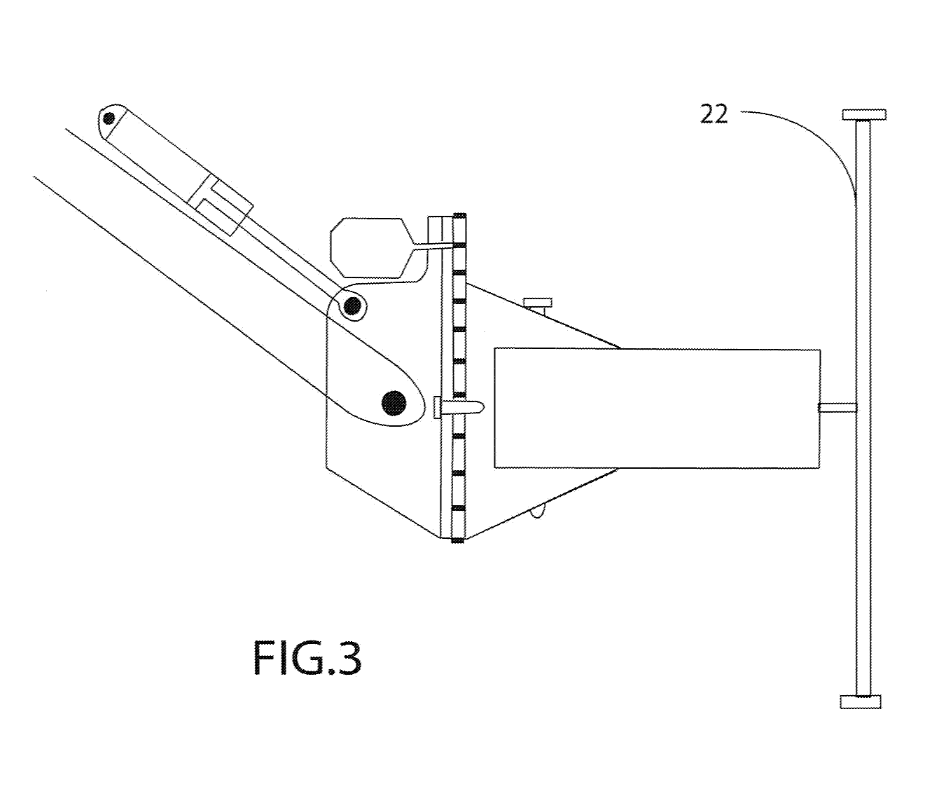

FIG. 3 shows the circular saw 22 at 90 degrees.

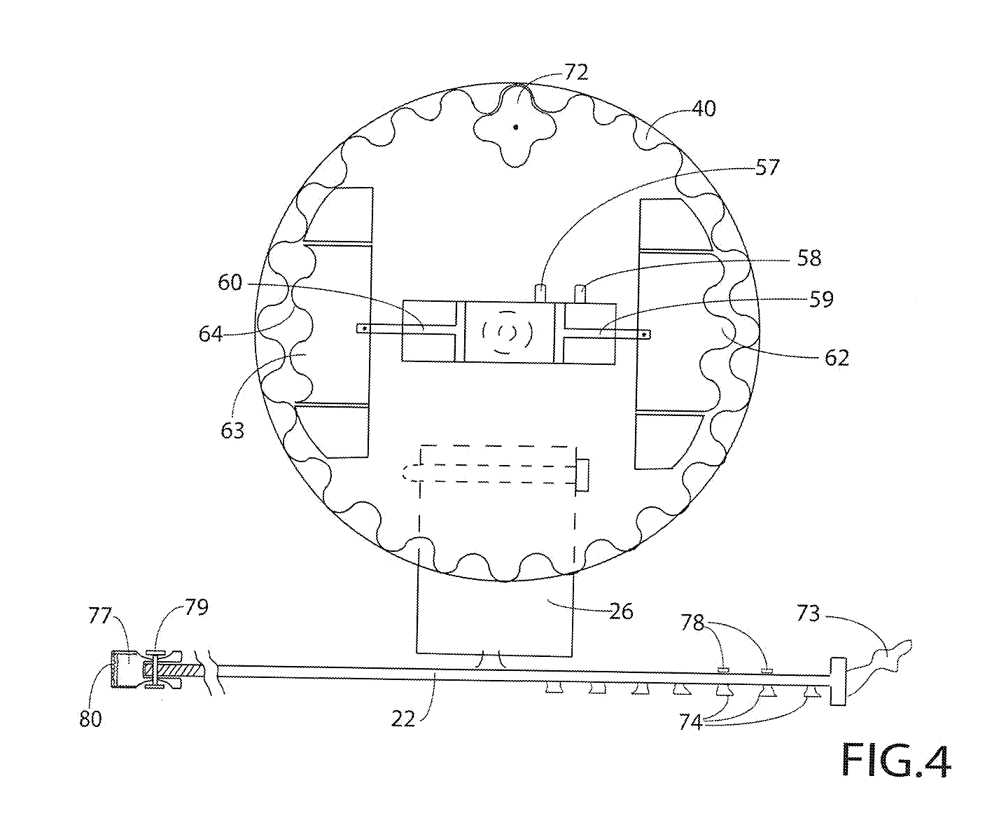

FIG. 4 shows the turret 40 in which a guidance block of two block devices right 62 and left 63 allow to lock the hydraulic motor 72 at two positions, one at half-step. The right block device 62 is activated by a right piston 59 and the left block device 63, shifted by a half-step 64 with respect to the right block device 62, is activated by a left piston 60. A hydraulic control 61 determines the positioning of the pistons 59,60. The circular saw 22 is seen in vertical position. Cutting teeth 73 and polishing teeth 74 can be seen on the saw, with clipping bolts 78 used to fix the cutting teeth on the saw. The saw is being cut to show at the same time at either end the cutting teeth 73 and the polishing teeth 74 coupled with an abrasive face 80 of a segment 77. One sees the oil pipe input 57 and the oil pipe output 58 that activate the right piston 59.

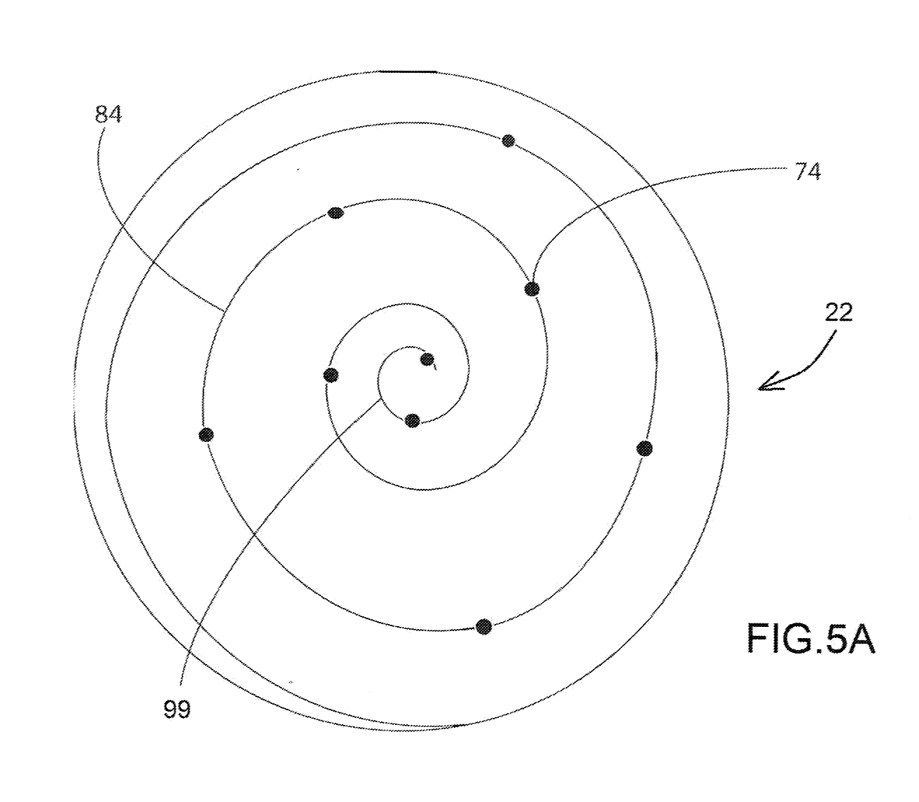

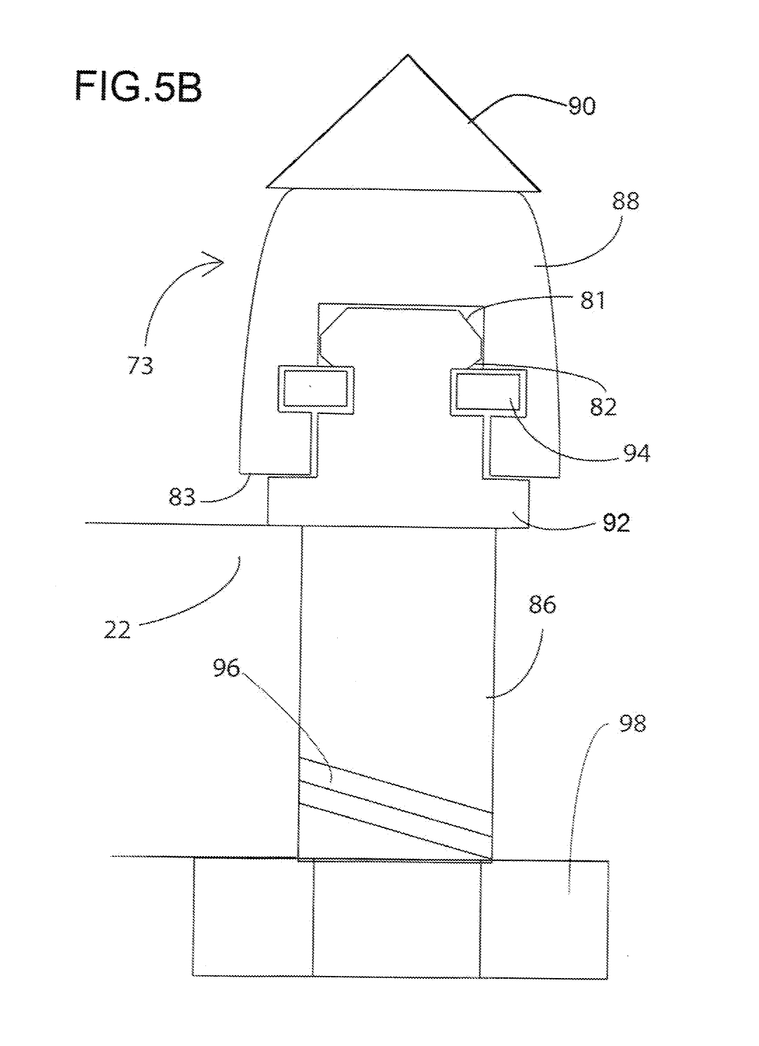

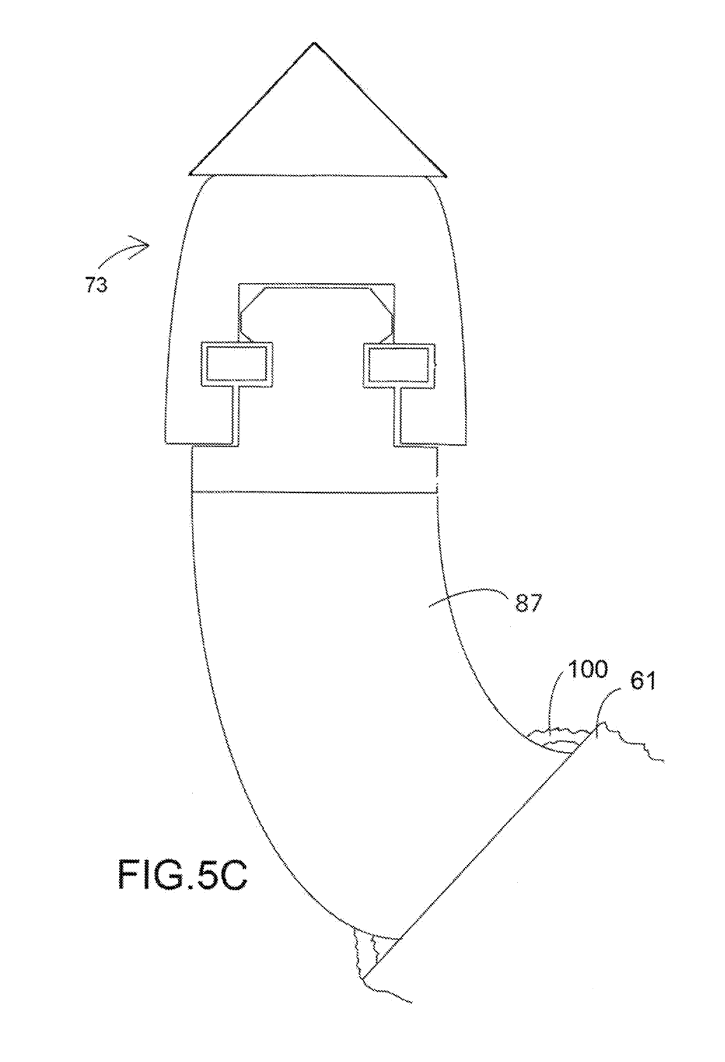

FIG. 5A shows the circular saw 22 in face view with the positioning of polishing teeth along a spiral arrangement 84, the reason being to ascertain that the passing of the teeth is not in a channel but the effect is spread out over each little area of a polished work piece for a desired smoothness. Distance 99 between teeth 74 gets progressively larger as it proceeds from the center of the saw to the peripheral edge.

FIG. 5B shows a cutting tooth made of two parts, namely a shank 86 which is straight and a sleeve tooth 88 designed to form a female over the shank 86 and which is equipped with a hard tip 90. A clipping tip 92 surmounts the shank 86 and is provided for receiving a locking element 94 which also locks the sleeve tooth. In the clipping tip 92 there is an entrance bevel of about 30 degrees to facilitate the entrance of the sleeve tooth; there is also an exit bevel 82 to facilitate the exit of the sleeve tooth with the help of a knockoff flat 83 which may be hit by a hammer. There are threads 96 to permit the fastening with a nut 98.

FIG. 5C shows an angled shank 87 which may be to the left or to the right and is preferably of about 30 degrees. The angled shank is preferably welded 100 to a peripheral band 61.

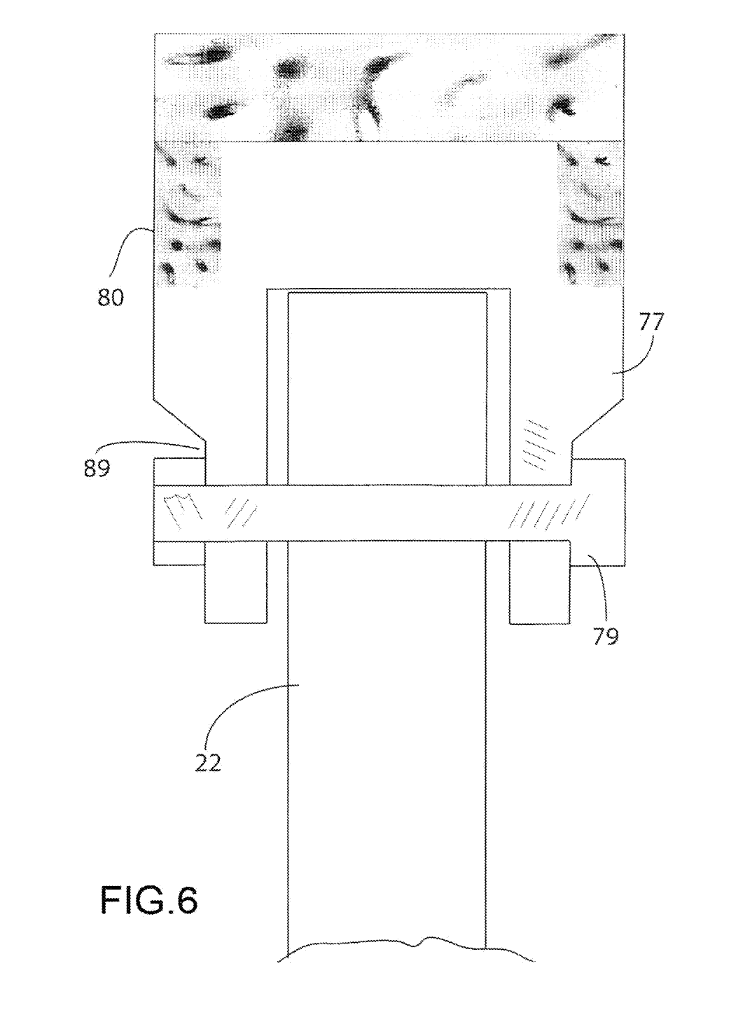

FIG. 6 shows at the edge of the circular saw 22, in a cut view, the segment 76 offering a re-entrant angle 89 to permit the hiding of the clipping bolt 79 for not interfering with the polishing by the abrasive face 80.

### SUMMARY

A device comprising a circular saw 22 mounted to a mechanical equipment comprising a support device 23 comprising an internal motor 24 driving a rotation shaft 28 engaging the circular saw.

The mechanical equipment comprises a support device moving around a rotation pivot 30 being peripheral with respect to a lower rotation base 38 turning around a central axis 45 of a shovel stick 56. The lower rotation base also comprises a circular rack rail means moved by a pinion gear 41 driven by a hydraulic motor 72, thus providing a 360-degree rotation of the circular saw. These rack rail means comprise a ring gear 40 having teeth, and a matching block 62 corresponding to the ring gear teeth and an offset block 63 disposed on an opposite side of the ring gear and defining a half-step 64 destined to provide finer locking positions to the movement of the ring gear.

The lower rotation base further comprises a hydraulic cylinder 36 connected to the support device causing a movement around the rotation pivot 30 thus causing a raising of the support device from an angle of 0 to 135 degrees, thus sawing in space when the support device is rotating 360 degrees along the lower base.

The shovel stick comprises an upper stationary plate 42 disposed above the ring gear 40 and swivelling in accordance with movements of stretching or compressing of a hydraulic cylinder 49 of the shovel stick and thus providing a supplemental angular displacement.

Cutting teeth 73 and polishing teeth 74 are respectively located on a peripheral band of the saw and on the external side of the saw. Cutting teeth could be replace by an abrasive face 80.

Electronic means are used to program the saw in all different angular displacement.

It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the appended claims.

LEGEND

| | |
|---|---|
| 20 | Swing base |
| 22 | Circular saw |
| 23 | Support device |
| 24 | Inner motor |
| 26 | Stand |
| 28 | Rotation shaft |
| 30 | Rotation pivot |
| 32 | Cylinder rod |
| 34 | Dowel |
| 36 | Hydraulic cylinder |
| 38 | Lower rotation base |
| 40 | Ring gear |
| 41 | Pinion gear |
| 42 | Upper fixed plate |
| 45 | Central axis |
| 48 | Shovel cylinder body |
| 49 | Cylinder rod |
| 56 | Shovel stick |
| 57 | Oil pipe input |
| 58 | Oil pipe output |
| 59 | Right piston |
| 60 | Left piston |
| 61 | Peripheral band |
| 62 | Matching block |
| 63 | Offset block |
| 64 | Half-step |
| 72 | Hydraulic motor |
| 73 | Cutting teeth |
| 74 | Polishing teeth |
| 76 | Segment for tooth |
| 77 | Segment for abrasive face |
| 78, 79 | Clipping bolts |
| 80 | Abrasive face |
| 82 | Exit bevel |
| 83 | Knockoff flat |
| 84 | Spiral arrangement |
| 86 | Shank |
| 88 | Sleeve |
| 89 | Re-entrant angle |
| 90 | Hard tip |
| 92 | Clipping tip |
| 94 | Locking element |
| 96 | Thread |
| 98 | Nut |
| 99 | Distance between teeth |
| 100 | Welded |

I claim:

1. A device comprising a circular saw (22) mounted to a mechanical equipment comprising a support device (23) comprising an internal motor (24) driving a rotation shaft (28) engaging said circular saw, said mechanical equipment comprising:
a support device (23) moving around a rotation pivot (30) peripheral with respect to a lower rotation base (38) turning about a central axis (45) of a shovel stick (56), said lower rotation base comprising a circular rack rail means moved by a pinion gear (41) driven by a hydraulic motor (72), thus providing a 360-degree rotation of said circular saw (22);
said lower rotation base (38) further comprising a hydraulic cylinder (36) connected to said support device (23) causing a movement around said rotation pivot (30) thus causing a raising of said support device from an angle of 0 to 135 degree, thus sawing in space when said support device is rotating 360 degrees along said lower base.

2. The device of claim 1 wherein said shovel stick (56) comprises an upper stationary plate (42) disposed above said ring gear (40) and swivelling in accordance with movements of stretching or compressing of a hydraulic cylinder (49) of said shovel stick (56) and thus providing a supplemental angular displacement.

3. The device of claim 1 involving cutting teeth (73) located on a peripheral band (61) of said saw and polishing teeth (74) installed on an external side of said saw (22).

4. The device of claim 1 wherein said rack rail means comprise a ring gear (40) having teeth, a matching block (62) corresponding to said ring gear teeth and an offset block (63) disposed on an opposite side of said ring gear and defining a half-step (64) destined to provide finer locking positions to the movement of said ring gear.

5. The device of claim 1 comprising electronic means to program said saw in said angular displacement.
